(19) United States
(12) Patent Application Publication
(10) Pub. No.: US 2018/0201813 A1
(43) Pub. Date: Jul. 19, 2018

(54) SELF-ADHESIVE WATERPROOF SHEET WITH MODIFIED SYNTHETIC RUBBER

(71) Applicants: Harry Kim, Marietta, GA (US); Jong Yoon Jeong, Chungcheongbuk-do (KR)

(72) Inventors: Jong Yoon JEONG, Chungcheongbuk-do (KR); Byeong Deok CHOI, Chungcheongbuk-do (KR)

(21) Appl. No.: 15/440,742

(22) Filed: Feb. 23, 2017

(30) Foreign Application Priority Data
Jan. 19, 2017 (KR) 10-2017-0009033

(51) Int. Cl. C09J 109/08; C09J 7/02; C09J 107/02; B32B 7/12; B32B 27/32

(52) U.S. Cl. CPC C09J 109/08; C09J 7/0296; C09J 107/02; B32B 7/12; B32B 27/32; B32B 2323/046; C09J 2409/00; B32B 2307/7265; B32B 2395/00; B32B 2323/043; C09J 2407/00

(57) ABSTRACT

Provided is a self-adhesive waterproof sheet with a modified synthetic rubber and more particularly, the self-adhesive waterproof sheet with a modified synthetic rubber includes an asphalt compound layer; a protective film layer that is formed on the asphalt compound layer and is oriented in two directions with respect to elongation by mixing high density polyethylene (HDPE) and methallaocene low density polyethylene (M.PE) at a ratio of 30 wt % to 70 wt % :30 wt % to 70 wt %; and a release sheet formed to be detachably attached to a lower portion of the asphalt compound layer.

### TECHNICAL FIELD

The present invention relates to a self-adhesive waterproof sheet with modified synthetic rubber and particularly, to a self-adhesive waterproof sheet with modified synthetic rubber in which that since dispersion (spreadability) is improved to minimize sensitivity even in a low-temperature, high-temperature, and low-viscosity state when mixing an asphalt composition by adding benton to a latex, an change in manufacturing and a manufacturing method can be minimized when forming a waterproof sheet product and in this case, since little change in physical properties of the latex occurs and a synthetic rubber obtained by crafting EPDM to maleic anhydride as an EPDM-added polymer having no butadiene component has excellent weather resistance to reduce the occurrence of oxidation due to sunlight and oxygen in the air and improve the lifespan of the waterproof sheet and the synthetic rubber as a polymer improving the affinity with the polar molecule products has excellent adhesion to any adhered surface and maintains a low-temperature characteristic even at −40° C. or less, breakage of the waterproof sheet and deterioration of adhesion can be minimized due to cold resistance.

### BACKGROUND ART

A conventional waterproof sheet which has been used for waterproofing of building structures and roofs has a form in which modified asphalt is coated on upper and lower surfaces of glass fiber and the like with a predetermined thickness, sand is coated thereon to block ultraviolet, and a release paper is attached to the bottom to prevent foreign substances from being attached to the coated modified asphalt.

However, in the waterproof sheet, because a compound of the modified asphalt is oxidized due to ultraviolet, weather resistance of the waterproof sheet is deteriorated and a pushing phenomenon occurs by external impact due to low viscosity at a high temperature (in summer).

Further, in the waterproof sheet, since a weight of the product becomes heavy by excessive addition of a filler, the construction is delayed and inconvenience of the construction is caused, and at a low temperature, the sheet is easily damaged even in external impact.

Further, when the waterproof sheet is attached to concrete structures and other adhered surfaces, it is inconvenient that the adhesive surface of the waterproof sheet needs to be molten by using a torch lamp for increasing adhesion. In this case, since a part which is not heated by heat is attached to the adhered surface in a non-molten state, a part which is not attached to the adhered surface is generated and thus there is a problem in that floating and leaking phenomena frequently occur.

In addition, when the waterproof sheet is heated by the torch lamp, a piercing phenomenon of the part of the waterproof sheet frequently occurs and thus there is a fatal disadvantage in that a waterproof function is lost.

As described above, in the related art, it is considered that the function of the waterproof sheet needs not to be changed even when the structure is flowing, but force (tension) caused by the flowing of the structure (occurrence of cracks) may not be controlled by one waterproof sheet and a breakage phenomenon of the waterproof sheet occurs and the leakage occurs. Accordingly, elasticity of the waterproof sheet is more important than tensile strength of the waterproof sheet.

Meanwhile, an asphalt self-sensitive waterproof sheet in which films having UV resistance are stacked does not exhibit a function at a low temperature and a high temperature because in physical properties of asphalt itself, cold resistance and heat resistance are significantly deteriorated. Further, a compound made of a synthetic rubber has a problem in that attachment at a low temperature and a high temperature is excellent, but initial adhesion is deteriorated and thus a floating phenomenon occurs sometimes. Particularly, in the same type of waterproof sheet, there is convenience of the construction, but leakage occurs at overlapping portions or corner portions and floating occurs due to shrinkage and relaxation of the waterproof sheet according to a temperature change.

Further, ethylene propylene diene monomer (EPDM) that has been frequently used for waterproofing in civil engineering and construction fields is a polymer consisting of a copolymer of ethylene, propylene and dienes and an elastomeric material with excellent weather resistance, heat-aging resistance and ozone resistance.

The EPDM has been developed as a waterproof material which is the most popular in the world because particularly, initial physical properties may be maintained for 20 years or more due to excellent chemical stability and there is no change in physical properties even by external environmental factors including vibration, moisture, chemicals, and the like. Currently, since most of important buildings in the country and abroad are waterproofed by the EPDM, the EPDM has been widely used.

Meanwhile, the EPDM itself is very chemically stable and thus does not react chemically with other materials, so that an adhesive capable of completely bonding sheets and sheets has not been developed. As a result, detachment of joint portions is a problem, and recently, thermally welded EPDM has been developed and sheets may be welded by hot air and then the problems are much solved.

In the related art, when the EPDM waterproof sheet is bound to the ground such as a concrete surface, a solvent type adhesive needs to be used, and in this case, many odors and toxic gases are generated during operation, and there are environmental and health risks such as a case where the operator may cause hallucination symptoms depending on a type of solvent.

In addition, since the EPDM waterproof sheet needs to be applied while applying the adhesive, sufficient knowledge of the adhesive is required, and the work process is complicated and thus workability is deteriorated.

Meanwhile, when conventional thermoplastic rubber SBS is used, tensile strength is increased by styrene at high viscosity and a low temperature and thus the content of plasticizer needs to be increased due to reduction of adhesion of the product at a low temperature such as autumn and winter. There are problems in that a detachment phenomenon from an adhered surface occurs even at a slight temperature rise and there is a limit to improve heat resistance due to a thermoplastic property, and it is required to change manufacturing and a manufacturing method according to a temperature when producing a sheet product.

Further, in various kinds of polymers including SBS rubber and the like which are added in the asphalt composition used in the related art, oxidation is caused by sunlight or oxygen in the air and thus ozone resistance and weather resistance are lowered. In addition, when an adherend is polar, the adhesion of the waterproof sheet is lowered, the sheet is shrunk after a long time due to a large plasticizer content, and the adhesion at low temperature is lowered due to the limit of cold resistance.

### DISCLOSURE

### Technical Problem

The present invention has been made in an effort to provide a self-adhesive waterproof sheet with a modified synthetic rubber having advantages of extending a lifespan of the waterproof sheet by reducing occurrence of oxidation due to sunlight and oxygen in the air and preventing adhesion from being deteriorated even when an adhered surface is exposed in sunlight due to excellent weather resistance by adding a synthetic rubber in which EPDM having no butadiene component is crafted to maleic anhydride and preventing flowing of the waterproof sheet even at a high temperature or low viscosity while preventing the waterproof sheet from being detached even though partially adsorbed with water and minimizing a change in manufacturing and a manufacturing method of the waterproof sheet by minimizing thermosensitivity even at low temperature, high temperature, and low viscosity states when an asphalt composition is mixed due to improved dispersion (spreadability), by adding betone having bipolarity in which the edge part is positive (+) and the surface is negative (−).

### Technical Solution

An aspect of the present invention provides a self-adhesive waterproof sheet with a modified synthetic rubber including: an asphalt compound layer; a protective film layer that is formed on the asphalt compound layer and is oriented in two directions with respect to elongation by mixing high density polyethylene (HDPE) and methallaocene low density polyethylene (M.PE) at a ratio of 30 wt % to 70 wt % :30 wt % to 70 wt %; and a release paper formed to be detachably attached to a lower portion of the asphalt compound layer.

Herein, the asphalt compound layer may be prepared by primarily preparing a first mixture by mixing 15 to 25 wt % of natural rubber latex (NR LATEX), 15 to 25 wt % of styrene butadiene latex (SB LATEX), and 45 to 65 wt % of process oil in a first mixing tank, heating a mixture at 150° C. to 170° C. for 2 to 3 hrs to evaporate moisture, adding 5 to 15 wt % of benton, and then mixing and stirring the mixture, secondarily preparing a second mixture by adding 70 to 80 wt % of asphalt and 20 to 30 wt % of a styrene-butadiene-styrene block copolymer (SBS rubber) in a second mixing tank, and mixing and stirring the mixture for 2 to 4 hrs while heating the mixture at 170° C. to 190° C. to dissolve the SBS rubber and a synthetic rubber in the asphalt, and then adding 50 to 65 wt % of the second mixture, 5 to 10 wt % of the first mixture herein, 5 to 15 wt % of a synthetic rubber in which ethylene propylene diene monomer (EPDM) is crafted to maleic anhydride, 4 to 20 wt % of high-molecular weight petroleum resin, 2 to 15 wt % of a tackifier, 5 to 25 wt % of low molecular weight petroleum resin, 0.5 to 2 wt % of a thickener, 5 to 30 wt % of a filler, and 3 to 20 wt % of a plasticizer, with respect to 100 wt % of the entire asphalt compound layer in the second mixing tank, and then mixing and stirring the mixture at 120° C. to 150° C. for 1 to 2 hrs.

### Advantageous Effects

According to the present invention, since dispersion (spreadability) is improved to minimize sensitivity even in a low-temperature, high-temperature, and low-viscosity state when mixing an asphalt composition by adding benton to a latex, a change in manufacturing method when forming a waterproof sheet product can be minimized, thereby manufacturing a waterproof sheet with reliability.

Further, since a synthetic rubber in which EPDM is crafted to maleic anhydride as an EPDM-added polymer having no butadiene component has excellent weather resistance to reduce the occurrence of oxidation due to sunlight and oxygen in the air, the synthetic rubber improves the lifespan of the waterproof sheet and the synthetic rubber as a polymer improving the affinity with the polar molecule products has excellent adhesion to any adhered surface and maintains a low-temperature characteristic even at −40° C. or less, the synthetic rubber can minimize breakage of the waterproof sheet and deterioration of adhesion due to cold resistance.

### DESCRIPTION OF DRAWINGS

FIG. 1 is a diagram illustrating a self-adhesive waterproof sheet with a modified synthetic rubber according to the present invention.

### EXPLANATION OF REFERENCE NUMERALS AND SYMBOLS

100: Self-adhesive asphalt 102: Asphalt compound layer

104: Protective film layer 106: Release paper

### Best Mode

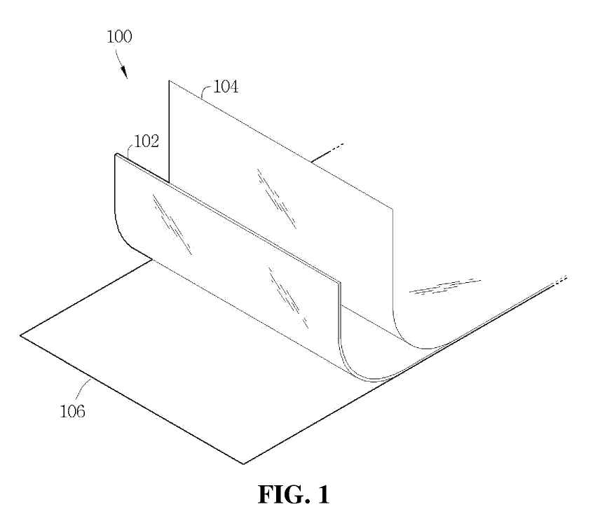

A configuration of a self-adhesive waterproof sheet with a modified synthetic rubber according to the present invention will be described below with reference to FIG. 1. The self-adhesive waterproof sheet with a modified synthetic rubber is constituted by an asphalt compound layer made of asphalt as a main material, a protective film layer, and a release paper. The asphalt compound layer is a waterproof material that substantially plays a waterproof role, the protective film layer is formed on the asphalt compound layer to protect the asphalt compound layer, and the release paper is detachably formed below the asphalt compound layer, and as a result, the asphalt compound layer may be attached to a base surface after removing the release paper in waterproofing construction.

The protective film layer has two directions with respect to elongation by mixing high density polyethylene (HDPE) and methallaocene low density polyethylene (M.PE) at a ratio of 30 wt % to 70 wt % :30 wt % to 70 wt %; and a release paper formed to be detachably attached to a lower portion of the asphalt compound layer.

When describing a mixed ratio of the HDPE and the M.PE, when the content of the HDPE is less than 30 wt %, a crystallization speed is too delayed and costs are increased because expensive M.PE exceeds 70 wt %, and when the content of the HDPE is more than 70 wt %, the crystallization speed is too fast and a tearing phenomenon very frequently occurs in production of the film, and thus it is difficult to produce a good film. In addition, when the content of the M.PE is less than 30 wt %, the crystallization speed is too fast and thus a tearing phenomenon occurs in production of the film, and when the content of the M.PE is more than 70 wt %, the costs are increased as described above. Therefore, it is preferred that the mixed ratio of the HDPE and the M.PE is set in a range of 30 wt % to 70 wt % :30 wt % to 70 wt % according to a desired physical property.

Meanwhile, in the asphalt compound layer, a first mixture is primarily prepared by mixing 15 to 25 wt % of natural rubber latex (NR LATEX), 15 to 25 wt % of styrene butadiene latex (SB LATEX), and 45 to 65 wt % of process oil in a first mixing tank, stirring the mixture while heating at 150° C. to 170° C. for 2 to 3 hrs to evaporate moisture, adding 5 to 15 wt % of benton, and then mixing and stirring the mixture.

That is, when the NR LATEX and the SB LATEX are first mixed with oil due to the moisture, compatibility with other polymers is good and thus the NR LATEX and the SB LATEX are first mixed with the process oil. In addition, the NR LATEX has good adhesion, but flows down, and the SB LATEX may prevent the flow of a raw material at a high temperature due to high viscosity and serves as a thickener.

Accordingly, when the first mixture is prepared, it is preferred that the NR LATEX is added with 15 to 25 wt % with respect to 100 wt % of the first mixture. In this case, when the NR LATEX is added with less than 15 wt %, the NR LATEX becomes hard due to high viscosity and when the NR LATEX is added with more than 25 wt %, the viscosity may be smoothly adjusted through evaporation of moisture, but there is a problem in that the cost increases.

Further, since the SB LATEX has high viscosity, the viscosity is enhanced by mixing the NR LATEX, and it is preferred that the SB LATEX is added with 15 to 25 wt % with respect to 100 wt % of the first mixture. When the SB LATEX is added with less than 15 wt %, it is difficult to adjust the viscosity and when the SB LATEX is added with more than 25 wt %, due to high viscosity, mixing is difficult and compatibility is low.

In addition, the process oil is added for improving compatibility when the NR LATEX and the SB LATEX are mixed with other polymers, and it is preferred that the process oil is added with 45 to 65 wt % with respect to 100 wt % of the first mixture. When the process oil is added with less than 45 wt %, the compatibility does not occur as much as expected, and when the process oil is added with more than 65 wt %, the compatibility is increased in the mixing process while increasing the moisture, but it is difficult to expect an additional effect and only the cost increases.

Further, the benton is added with 5 to 15 wt % with respect to 100 wt % of the first mixture to prevent flowing (thixotropy) even in the case of high temperature or low viscosity and minimize detachment of the waterproof sheet even at the high temperature. A rubber polymer to which the benton is added has improved dispersion, and when the rubber polymer is mixed with the asphalt composition, thermosensitivity is minimized even in a low temperature, high temperature and low viscosity state, thereby minimizing changes in manufacturing and manufacturing method when a the waterproof sheet product is formed.

Accordingly, when the benton is added with less than 5 wt %, the expected effect may not be obtained and when the benton is added with more than 15 wt %, a further expected effect may not be obtained according to an additional addition.

As described above, when the first mixture is prepared in the first mixing tank, a second mixture is secondarily prepared separately by adding 70 to 80 wt % of asphalt and 20 to 30 wt % of a styrene-butadiene-styrene block copolymer (SBS rubber) in a second mixing tank different from the first mixing tank, mixing and stirring the mixture for 2 to 4 hrs while heating at 170° C. to 190° C. to dissolve the SBS rubber and a synthetic rubber in the asphalt.

Herein, the asphalt is a main material of the asphalt compound layer and added with 70 to 80 wt % with respect to 100 wt % of the entire second mixture, and it is preferred that 20 to 30 wt % of the SBS rubber is added therein.

The SBS rubber which is thermoplastic rubber is mixed with the asphalt to maintain high viscosity of the asphalt, and even at a low temperature, a state in which tensile strength is increased is maintained, and thus adhesion is not deteriorated even in autumn or winter. Herein, when the content of the plasticizer is increased, it is possible to prevent a detachment phenomenon from the adhered surface even at a slight temperature rise.

Accordingly, when the SBS rubber is added with 20 to 30 wt % with respect to 100 wt % of the entire second mixture, the largest effect may be expected.

As described above, when the second mixture is prepared in the second mixing tank, wt % of the entire second mixture prepared in the second mixing tank is converted into 50 to 65 wt % with respect to the 100 wt % of the entire asphalt compound layer and then the remaining additives are added therein.

That is, after the second mixture is prepared in the second mixing tank, the second mixture is not added to the second mixing tank again, but after the prepared second mixture in the second mixing tank is calculated to 50 to 65 wt % with respect to 100 wt % of the entire asphalt compound layer, the remaining additives to be described below are added to make the asphalt compound layer.

As a result, the asphalt compound layer is formed by adding 50 to 65 wt % of the second mixture with respect to 100 wt % of the entire asphalt compound layer the second mixing tank, adding 5 to 10 wt % of the first mixture herein, adding 5 to 15 wt % of a synthetic rubber in which ethylene propylene diene monomer (EPDM) is crafted to maleic anhydride, 4 to 20 wt % of high-molecular weight petroleum resin, 2 to 15 wt % of a tackifier, 5 to 25 wt % of low molecular weight petroleum resin, 0.5 to 2 wt % of a thickener, 5 to 30 wt % of a filler, and 3 to 20 wt % of a plasticizer, and then mixing and stirring for 1 to 2 hrs at 120° C. to 150° C.

The second mixture has a function of a self-adhesive waterproof material made of the asphalt as a main material and high viscosity to maintain a state in which tensile strength is increased even at a low temperature and prevent deterioration of adhesion even at a low temperature. The second mixture is added with 50 to 65 wt % with respect to 100 wt % of the entire asphalt compound layer composition, and in the case of adding less than 50 wt %, the waterproof function is deteriorated or a breakage at a low temperature may occur, and in the case of adding more than 65 wt %, the expected effect according to addition of other additives is slight, and thus it is preferred that the second mixture is added with 50 to 65 wt %.

The first mixture may prevent flowing of the asphalt compound layer even at high temperature or low viscosity, minimize a detached phenomenon even at a high temperature, and improve dispersion to minimize thermosensitivity even in a low temperature, high temperature, and low viscosity state. Accordingly, in the case of adding less than 5 wt %, it is difficult to obtain the expected effect and in the case of adding more than 10 wt %, the expected effect may be obtained, but a further expected effect according to an additional addition does not occur, and thus it is preferred that the first mixture is added with 10 to 15 wt %.

In addition, since the EPDM is bound to a single saturated hydrocarbon, polymerization with other polymers is difficult and thus compatibility, dispersion, and the like are not achieved well. However, in the present invention, the EPDM is crafted to maleic anhydride to improve affinity with non-polar materials and polar materials, and thus the problems are overcome.

Accordingly, the synthetic rubber in which the EPDM added in the composition of the asphalt compound layer according to the present invention is crafted to maleic anhydride entirely improves workability, compatibility and other functions.

The synthetic rubber in which the EPDM is crafted to maleic anhydride is added with 5 to 15 wt % with respect to 100 wt % of the entire composition of the asphalt compound layer, and in the case of adding less than 5 wt %, it is difficult to expect improvement of workability and compatibility, and in the case of adding more than 15 wt %, the expected effect may be obtained, but a further expected effect does not occur, and thus only cost increases.

In addition, the high molecular weight petroleum resin (requiring additional description of kinds and functions) is petroleum resin having a softening point of 100° C., such as terpene resin and phenolic resin to prevent flowing at a high temperature by increasing heat resistance, improve adhesion, and reinforce adhesive retention. In the case of mixing a small amount, an effect on physical properties is insignificant and in the case of using an excessive amount, unique odor of the petroleum resin and deterioration of the physical properties of conventional modified asphalt may occur, and thus the high molecular weight petroleum resin is added with 4 to 20 wt % as a proper range.

Further, the tackifier is a component for applying adhesion to the asphalt compound layer composition and it is preferred that the tackifier is added with 2 to 15 wt %.

Further, the low molecular weight petroleum resin (requiring additional description of kinds and functions) is petroleum resin having a softening point of 80° C. or less such as pine resin to improve adhesion at a low temperature and reinforcing adhesive retention by increasing cold resistance and reinforcing initial adhesion. In the case of mixing a small amount, an effect on physical properties is insignificant and in the case of using an excessive amount, there is no large effect as much as expected and thus the low molecular weight petroleum resin is added with 5 to 25 wt % as a proper range.

In addition, the thickener is added to increase viscosity and it is preferred that the thickener is added with 0.5 to 2 wt % with respect to 100 wt % of the entire composition of the asphalt compound layer. As the filler, generally, calcium carbonate (CaCo₃) which has low price and improves binding force between various polymers is added with 5 wt % to 30 wt %.

In the case of adding 5 wt % or more of filler, the effect is insignificant and only a specific gravity is increased, and in the case of adding 30 wt % or more of the filler, a price reduction effect occurs, but it is difficult to move and install due to decrease of adhesion, decrease of cold resistance due to viscosity increase, increase of a product weight due to high specific gravity, and a detachment phenomenon occurs when installing a wall, and the filler is added for improving bonding force, the price reduction effect, and adhesion due to polarity.

Further, the plasticizer is added to have permanently elastic and flexible properties by maintaining the viscosity of the asphalt compound layer composition in a gel state at room temperature. The plasticizer is made of at least one selected from paraffin oil, naphthenic oil, and aromatic oil of the process oils or may be used by mixing either glycol oil or mineral sprit oil with the process oil.

In this case, when the added ratio of the plasticizer is less than 3 wt %, the composition for forming the asphalt compound layer is easily cured and when the added ratio of the plasticizer is more than 20 wt %, there is a problem in that the gel state is not maintained and the plasticizer flows down.

1. A self-adhesive waterproof sheet with a modified synthetic rubber, comprising:
an asphalt compound layer;
a protective film layer that is formed on the asphalt compound layer and is oriented in two directions with respect to elongation by mixing high density polyethylene (HDPE) and methallaocene low density polyethylene (M.PE) at a ratio of 30 wt % to 70 wt % :30 wt % to 70 wt %; and
a release paper formed to be detachably attached to a lower portion of the asphalt compound layer.

2. The self-adhesive waterproof sheet with a modified synthetic rubber of claim 1, wherein the asphalt compound layer is prepared by
primarily preparing a first mixture by mixing 15 to 25 wt % of natural rubber latex (NR LATEX), 15 to 25 wt % of styrene butadiene latex (SB LATEX), and 45 to 65 wt % of process oil in a first mixing tank, heating a mixture at 150° C. to 170° C. for 2 to 3 hrs to evaporate moisture, adding 5 to 15 wt % of benton, and then mixing and stirring the mixture,
secondarily preparing a second mixture by adding 70 to 80 wt % of asphalt and 20 to 30 wt % of a styrene-butadiene-styrene block copolymer (SBS rubber) in a second mixing tank, and mixing and stirring the mixture for 2 to 4 hrs while heating the mixture at 170° C. to 190° C. to dissolve the SBS rubber and a synthetic rubber in the asphalt, and then
adding 50 to 65 wt % of the second mixture, 5 to 10 wt % of the first mixture herein, 5 to 15 wt % of a synthetic rubber in which ethylene propylene diene monomer (EPDM) is crafted to maleic anhydride, 4 to 20 wt % of high-molecular weight petroleum resin, 2 to 15 wt % of a tackifier, 5 to 25 wt % of low molecular weight petroleum resin, 0.5 to 2 wt % of a thickener, 5 to 30 wt % of a filler, and 3 to 20 wt % of a plasticizer, with respect to 100 wt % of the entire asphalt compound layer in the second mixing tank, and then mixing and stirring the mixture at 120° C. to 150° C. for 1 to 2 hrs.
